(19) United States
(12) Patent Application Publication
(10) Pub. No.: US 2014/0293665 A1
(43) Pub. Date: Oct. 2, 2014

(54) Damage Limitation

(71) Applicant: Control Techniques Limited, Newtown (GB)

(72) Inventors: Simon David Hart, Welshpool (GB); Antony John Webster, Montgomery (GB); Kondala Rao Gandu, Newtown (GB)

(73) Assignee: Control Techniques Limited, Newtown (GB)

(21) Appl. No.: 14/228,953

(22) Filed: Mar. 28, 2014

(30) Foreign Application Priority Data
Mar. 28, 2013 (IN) 1204/MUM/2013

(51) Int. Cl. H02M 1/36

(52) U.S. Cl. CPC H02M 1/36
USPC 363/49

(57) ABSTRACT

A damage limitation approach comprising determining that a voltage produced by a rectifier circuit is indicative of a fault and consequently controlling a switch operable to bypass a resistive element of a circuit via which the rectifier circuit is supplied.

### CROSS-REFERENCE TO RELATED APPLICATION

This application claims the benefit and priority of Indian Patent Application No. 1204/MUM/2013 filed Mar. 28, 2013. The entire disclosure of the above application is incorporated herein by reference.

### FIELD

This disclosure relates to damage limitation. In particular, but without limitation, this disclosure relates to limiting the damage caused by rectifier circuits that are supplied by a soft-start resistance and which are either faulty or are being operated in a manner other that for which they were designed.

### BACKGROUND

Electrical power can be provided for use in the form of a Direct Current (DC) voltage and also in the form of an Alternating Current (AC) voltage that has been rectified by applying an AC voltage waveform to a half- or full-wave rectifier so as to produce a rectified voltage. One type of rectifier employs a plurality of capacitances and diodes in combination to double, or otherwise multiply, an input AC voltage that is being rectified. Rectifiers may be employed in conjunction with soft-start circuits having a resistive element and a switch, wherein a soft-start circuit is arranged, when a voltage is initially provided to the rectifier, to cause current supplied by a power source to the rectifier to flow via the resistive element thereby limiting peak current during circuit initialisation. Once one or more predefined criteria are complied with, the switch is operated to short-circuit the resistive element and remove the resistive element's limiting influence on the current.

### SUMMARY

Aspects and features of the present disclosure are set out in the appended claims.

In an example approach for use with a device having a rectifier circuit and a resistive soft-start circuit coupled to an input of the rectifier circuit, a voltage output by the rectifier circuit is monitored and an assessment is made as to whether or not the monitored voltage is indicative of a fault. In the event that the assessment determines that the monitored voltage is indicative of a fault, a switch operable to allow current passing between the source and the rectifier circuit to bypass the resistive element is controlled so as to more it from an open position to a closed position or vice versa.

If the assessment determines that the monitored voltage is below an undervoltage threshold for a predetermined period or longer and/or that the rate of change of the monitored voltage is below a predetermined rate of voltage change, then the switch is closed to bypass a resistive element of the soft-start circuit. This increases the current that is drawn by the faulty circuit thereby potentially allowing damage to occur; however, by increasing the current that is drawn, an upstream overcurrent protection device that would not otherwise have been activated may then act to break the circuit that feeds the rectifier.

If the assessment determines that the monitored voltage is above an overvoltage threshold, and optionally further determines that the monitored voltage is below a damage level threshold, then the switch is closed.

If the assessment determines that the monitored voltage is above a damage level threshold, then the switch is closed. This increases the current that is drawn by the faulty circuit thereby potentially allowing damage to occur; however, by increasing the current that is drawn, an upstream overcurrent protection device that would not otherwise have been activated may then act to break the circuit that feeds the rectifier.

Although the approaches described herein may not prevent damage occurring to the rectifier circuit and/or the soft-start circuit, damage is advantageously limited to rectifier and soft-start circuits and other components that are in the immediate vicinity thereof and the chances of catastrophic damage, such as fire or explosion, occurring are reduced.

### DRAWINGS

Examples of the present disclosure will now be explained with reference to the accompanying drawings in which:

FIG. 1 shows a circuit diagram of an exemplary circuit to which the approaches described herein may be applied;

FIG. 2 shows the circuit of FIG. 1 connected to an electricity transmission system and associated generator;

FIG. 3 is a pictorial representation of the various operating conditions discussed herein;

FIG. 4 shows a flow chart illustrating an approach for limiting damage when a voltage provided by a rectifier is below an undervoltage threshold;

FIG. 5 shows a flow chart illustrating an approach for limiting damage when a voltage provided by a rectifier is above an overvoltage threshold; and

FIG. 6 shows a flow chart illustrating an approach for limiting damage when a voltage provided by a rectifier is above a damage level threshold.

### DETAILED DESCRIPTION

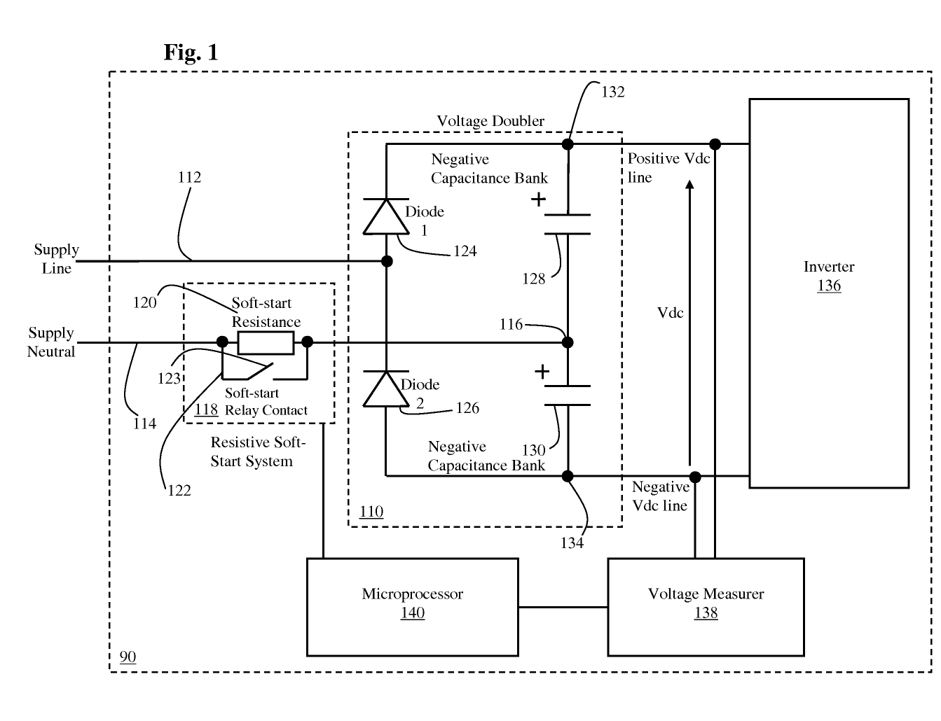

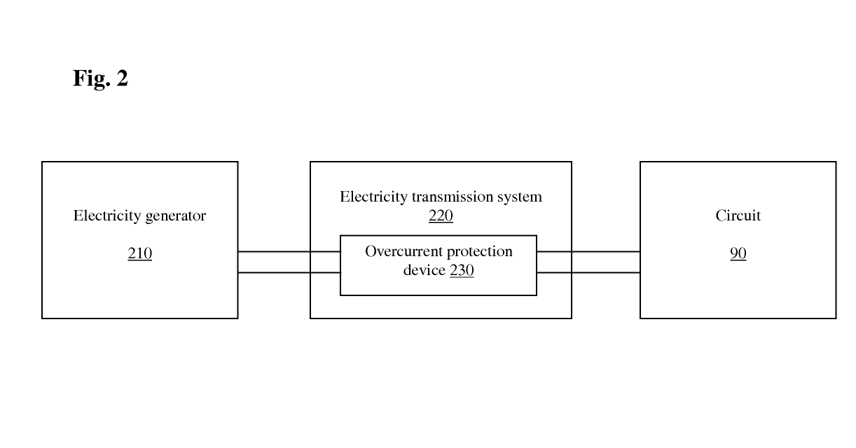

FIG. 1 shows a circuit diagram of an exemplary circuit 90 to which the approaches described herein may be applied. In particular, a rectifier 110, in this case a capacitive voltage doubler, is supplied with an AC input voltage that is provided between a supply line 112 and a supply neutral line 114. In this example, the supply line neutral 114 is connected to an input 116 of the rectifier 110 via a soft-start system 118 that comprises a resistive element, in this case a soft-start resistance 120, and a short circuiting leg 122 comprising a switch 123 that is arranged to short circuit the soft-start resistance 120 by closing a soft-start relay contact of the short circuiting leg 122 when appropriate. The rectifier 110 comprises a pair of diodes 124, 126 and a pair of capacitances 128, 130 that in conjunction perform half-wave rectification of the AC voltage that is provided between the supply line 112 and the supply neutral 114. The rectifier outputs a rectified (DC) voltage between first and second output points 132 and 134 (indicated in FIG. 1 by the reference sign Vdc). The DC voltage produced by the rectifier 110 is then provided to a load which, in the case of the example of FIG. 1, is an inverter 136 (a DC to AC converter). A voltage measurer 138 is arranged to measure the DC voltage between the output points 132, 134 of the rectifier 110 and to provide information about the measured voltage to a microprocessor 140. The microprocessor 140 is arranged to process information received from the voltage measurer 138 (thereby detecting the voltage at the output of the rectifier circuit) and control the switch 123 of the short circuiting leg 122 based upon that processing. The AC voltage provided to the circuit of FIG. 1 between the supply line 112 and the supply neutral 114 may be provided by an electricity generator 210 (see FIG. 2) and electricity transmission system 220 that may be owned and/or operated by a third party. Furthermore, the electricity transmission system 220 will generally have its own protection devices including an overcurrent protection device 230 arranged to trip out, and therefore stop the transmission of electricity by the electricity transmission system 220, in the event that the current drawn through at least a part of the electricity transmission system 220 is greater than a predetermined overcurrent amount.

If one or more of the capacitances 128, 130 of the circuit of FIG. 1 malfunctions so that it effectively acts as a short circuit, then the circuit may draw more current than would be expected for normal operation. If such a fault condition occurs whilst the switch 123 of the short circuiting leg 122 is open, then the increase in current drawn may not be sufficient to trip out the overcurrent protection device 230. In such circumstances, the passing of an elevated current through the soft-start resistance 120 may overheat the soft-start resistance 120 which may catch fire, melt, and/or damage the enclosure in which it is located and/or any nearby componentry. In such circumstances the fault condition will only end when the soft-start resistance 120 breaks down or gets sufficiently hot to disconnect itself—for example by desoldering itself from a Printed Circuit Board (PCB) to which it is mounted.

Also, in the event that a supply voltage substantially higher than that for which the rectifier 110 was designed to operate is provided between the supply line 112 and the supply neutral 114 whilst the switch 123 of the short circuiting leg 122 is open, then the current passing through the soft-start resistance 120 may be sufficient to cause the soft-start resistance 120 to overheat and/or to ignite and furthermore, the excess voltage provided across the capacitances 128, 130 may be sufficient to cause them to start to boil off or vent their electrolytes and they may overheat. Further, if an electrolytic capacitance has boiled off or vented some of its electrolyte then the value of that capacitance in Farads will fall and the amount of energy dissipated in the capacitance with each AC cycle will increase—thereby starting a vicious circle which may cause the capacitance to ignite and/or explode.

Although the concept of resistive soft-start systems is that they are designed to control the operation of a circuit upon initialisation, if fault conditions are detected for the circuit, then the soft-start system may be used to either limit the fault or alternatively exacerbate the fault so as to force third party protection devices to trip out thereby bringing about an end to the fault before any catastrophic damage occurs.

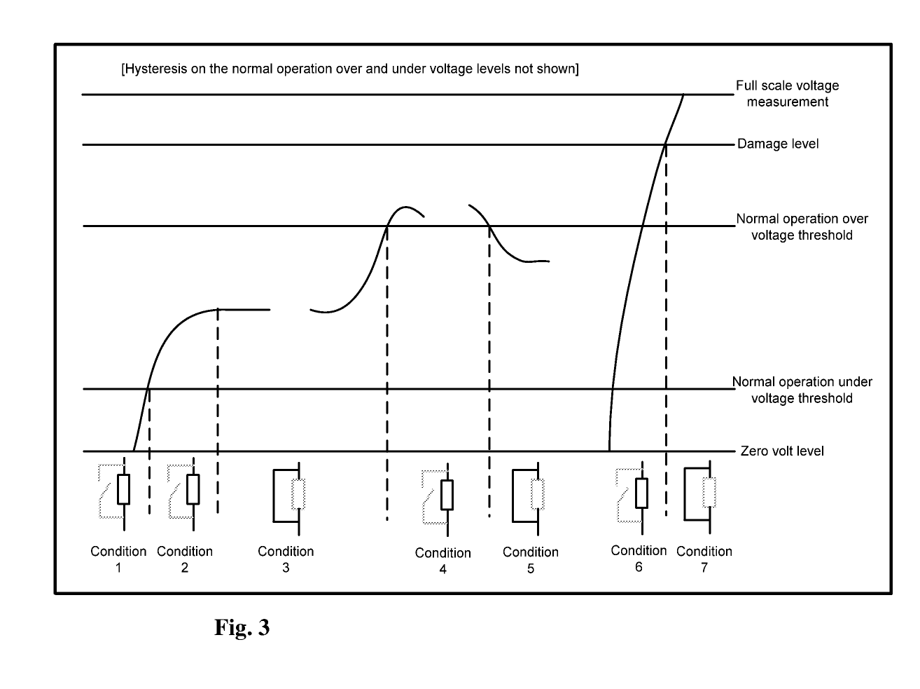

FIG. 3 shows a pictorial representation of various operating conditions that may apply to the circuit of FIG. 1. In particular a number of distinct conditions—labelled ‘condition 1’ to ‘condition 7’ along with representative voltage waveforms as detected, for example, between the output points 132 and 134 of the rectifier 110. Also shown are a number of output voltage thresholds.

In normal operation, one would expect that, upon connection of the circuit 90 to the electricity transmission system 230, the switch 123 of the short circuiting leg 122 would be open and the voltage detected by the voltage measurer 138 would rise from zero at at least a predetermined rate of voltage change until it exceeded a normal operational undervoltage threshold and subsequently plateaued or stabilised—as illustrated by conditions 1 and 2 of FIG. 3. The switch 123 would then be closed—as illustrated by condition 3 of FIG. 3 and one would expect the voltage detected by the voltage measurer 138 to remain relatively constant thereafter. However, in circumstances where the voltage detected by the voltage measurer 138 does not reach the voltage threshold within a predetermined time period and/or the rate of change of the voltage detected by the voltage measurer 138 is less than a predetermined rate of change of voltage, then it may be concluded that one or more of the capacitances 128, 130 of the rectifier 110 are not operating normally and that a fault is occurring. For example, if one of the capacitances 128, 130 fails, then the voltage doubler of FIG. 1 will no longer function and so the voltage measured by the voltage measurer 138 is likely to be around half the value of the normal operation undervoltage threshold. Accordingly, upon determination by the microprocessor 140 that the voltage measured by the voltage measurer 138 is below a predetermined undervoltage threshold, the microprocessor 140 can control the switch 123 of the short circuiting leg 122 and close it so as to remove the current limiting influence of the soft-start resistance 120. In such circumstances the current drawn by the rectifier 110 would increase thereby enabling overcurrent protection device 230 to detect that too much current is being drawn and trip out.

As one possibility, in case a fault with one or more of the capacitances occurs after the switch 123 has been closed due to the criteria for condition 3 having been satisfied, the microprocessor 140 will continue to monitor the voltage measured by the voltage measurer 138 and, if that voltage is below the predetermined undervoltage threshold and one or more predetermined conditions apply—for example, the voltage being below the predetermined undervoltage threshold for more than a predetermined time period and plateauing and/or the voltage having a rate of change below a certain threshold—continue to keep the switch 123 closed. By using the predetermined conditions, a normal power down operation can be distinguished from a fault condition.

FIG. 4 shows a flow chart according to the above-described approach. At step 410, the voltage output by the rectifier 110 is detected by way of the voltage measurer 138 performing a measurement and sending information about the measurement to the microprocessor. At step 420 the microprocessor determines whether or not the detected voltage is below an undervoltage threshold for normal operation. If not, then the approach returns to step 410. If so, then the approach proceeds to step 430 and closes the switch 123 of the short circuiting leg 122.

In circumstances where the voltage detected by the voltage measurer 138 has previously stabilised above the undervoltage threshold for normal operation and the switch 123 of the short circuiting leg 122 has been closed (condition 3 of FIG. 3), but the voltage detected by the voltage measurer 138 rises above an overvoltage threshold for normal operation, the circuit 90 is likely to be being supplied by an overvoltage that is in excess of that for which it was designed. Although to supply the circuit 90 with an overvoltage only slightly in excess of the overvoltage threshold for normal operation is unlikely to immediately bring about any catastrophic damage to any of the components of the circuit, prolonged or repeated exposure to excessive voltages can result in component damage. For example, repeated exposure to overvoltage can reduce the working lifetime of an electrolytic capacitor. Accordingly, upon determination by the microprocessor 140 that the voltage measured by the voltage measurer 138 is above a predetermined overvoltage threshold for normal operation (condition 4 of FIG. 3), the microprocessor 140 can control the switch 123 of the short circuiting leg 122 and open it so as to oblige current to flow through the soft-start resistance 120—thereby restricting current flow to the circuit 90 and reducing the amount of energy that can be imparted to the components of the circuit 90 when it is exposed to an overvoltage. Upon determination by the microprocessor 140 that the voltage measured by the voltage measurer 138 has returned to a value that is below the predetermined overvoltage threshold for normal operation, the microprocessor 140 can control the switch 123 of the short circuiting leg 122 and close it so that the circuit 90 can return to a normal mode of operation (condition 5 of FIG. 3).

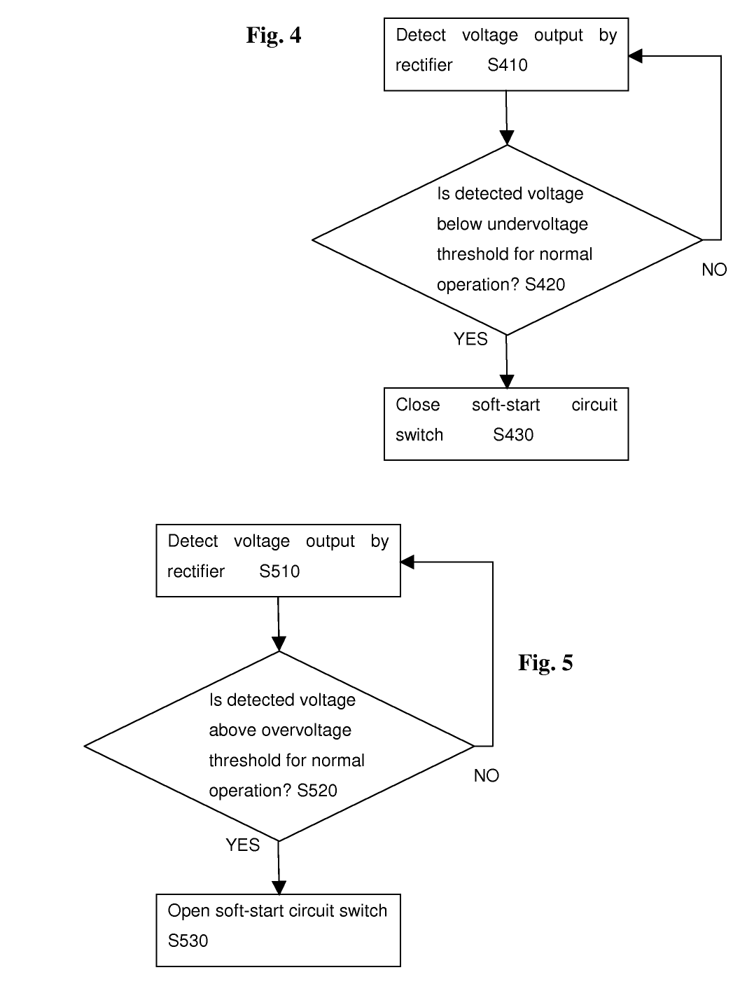

FIG. 5 shows a flow chart according to the above-described approach. At step 510, the voltage output by the rectifier 110 is detected by way of the voltage measurer 138 performing a measurement and sending information about the measurement to the microprocessor. At step 520 the microprocessor determines whether or not the detected voltage is above an overvoltage threshold for normal operation. If not, then the approach returns to step 510. If so, then the approach proceeds to step 530 and opens the switch 123 of the short circuiting leg 122.

In circumstances where the voltage detected by the voltage measurer 138 rises beyond the undervoltage threshold for normal operation but, unlike condition 3 does not plateau or stabilise, and instead continues to increase, then the plateauing or stabilising criteria of condition 3 that causes closure of the switch 123 may not be met and so the voltage detected by the voltage measurer 138 may rise from below the undervoltage threshold for normal operation to above the overvoltage threshold for normal operation without the switch 123 being closed (condition 6 of FIG. 3). In such circumstances, the soft-start resistance 120 may be subjected to a much higher voltage than it was specified to operate at. Consequent to Ohm's law, in such circumstances the soft-start resistance 120 will limit the current drawn by the rectifier 110 and so the overcurrent protection device will not trip before the soft-start resistance 120 and/or the capacitances 128, 130 have overheated and/or ignited/exploded. In order to address such issues, a damage level threshold may be defined and the microprocessor 140 arranged so that, once it determines that the voltage measured by the voltage measurer 138 is above a predetermined damage level threshold (condition 7 of FIG. 3), the microprocessor 140 can control the switch 123 of the short circuiting leg 122 by closing it so as to remove the current limiting influence of the soft-start resistance 120. In such circumstances the current drawn by the rectifier 110 would increase thereby enabling the overcurrent protection device 230 to detect that too much current is being drawn and trip out.

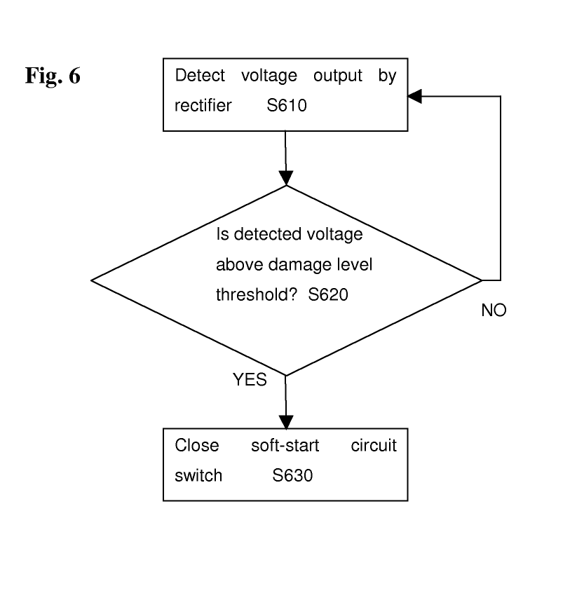

FIG. 6 shows a flow chart according to the above-described approach. At step 610, the voltage output by the rectifier 110 is detected by way of the voltage measurer 138 performing a measurement and sending information about the measurement to the microprocessor. At step 620 the microprocessor determines whether or not the detected voltage is above a damage level threshold. If not, then the approach returns to step 610. If so, then the approach proceeds to step 630 and closes the switch 123 of the short circuiting leg 122.

As one possibility, the microprocessor 140 is arranged to determine that the voltage measured by the voltage measurer 138 is above a predetermined overvoltage threshold for normal operation but below a predetermined damage level threshold and to control the switch 123 of the short circuiting leg 122 and open it upon making such a determination.

The above approaches of opening the switch 123 when the detected voltage is above overvoltage threshold for normal operation (described above with reference to condition 4) and of closing the switch 123 when the detected voltage is above damage level threshold (described above with reference to condition 7) are, in addition to being applicable for voltage doubler configuration rectifiers, also particularly applicable for other types of rectifiers, such as bridge rectifiers.

Although the above has been described with reference to the switch of the short circuiting leg comprising a relay, a person skilled in the art will appreciate that alternative or additional means of interrupting the short circuiting leg could equally be employed, for example, a semiconductor switch.

A person skilled in the art will appreciate that, although a number of different approaches to performing damage limitation have been described herein—in particular the approaches described with reference to: closing the switch when the measured voltage remains below an undervoltage threshold for too long; opening the switch when the measured voltage exceeds an overvoltage threshold; and closing the switch when the measured voltage exceeds a damage level threshold, any or all of the described approaches may be combined.

A person skilled in the art will recognise a number of different devices that may be employed to provide the overcurrent protection functionality of the overcurrent protection device described herein. For example, they will understand that the overcurrent protection may be embodied by a fuse, a circuit-breaker, a semiconductor switch and/or any other current based switch and they will further understand that reference herein to the overcurrent protection device tripping or tripping out refer to the act of breaking a circuit and may be performed both by passive devices, such as fuses, as well as active devices.

Although the above has described approaches that may be implemented by way of a microprocessor, the approaches described herein could equally be implemented without the use of a microprocessor. For example, the approaches described herein could be implemented by way of circuitry, which may be integrated circuitry such as one or more Application Specific Integrated Circuits (ASICs), arranged to have the functionality described herein.

A person skilled in the art will appreciate that threshold hysteresis may be employed in order to avoid rapidly switching the switch 123 of the short circuiting leg 122 in circumstances where the voltage measured by the voltage measurer 138 hovers around either the undervoltage threshold for normal operation or the overvoltage threshold for normal operation.

A person skilled in the art will understand that the overcurrent protection device which some of the approaches described herein aim to cause to trip out once a fault condition is detected, may be owned and/or operated by a third party and so the present disclosure need not be limited to include the overcurrent protection device.

A person skilled in the art will appreciate that, whilst the above has been described with reference to a circuit that drives a load that is an inverter, the present disclosure may be equally applied to circuits having other loads, such as a drive. Also, as inverters and loads may already have inherent voltage measuring capabilities, the voltage measurer and/or the microprocessor may be integral to the inverter/load. Advantageously, for such systems, the methods described herein may be implementable without the need for any additional hardware. Furthermore, in such cases, the inverter/load may be arranged to control whether, and if so to what extent, it draws current from the rectifier and may be further arranged to only draw current when the switch 123 of the short circuiting leg 122 is closed.

The methods described herein may be controlled and/or carried out by a computer and may be embodied in a computer readable medium carrying machine readable instructions arranged, upon execution by a processor of the computer, to cause the processor to carry out any of the methods described herein.

A person skilled in the art will appreciate that although the above is set out in terms of a capacitive voltage doubling rectifier, other kinds of rectifier may equally be employed, for example a bridge rectifier etc., and other types of capacitive voltage multiplying rectifier may equally be employed, for example a voltage quadrupler, etc.

A person skilled in the art will understand that, where mention is made above of capacitances, those capacitances may be manifested in the form of one or more capacitors, for example a bank of capacitors, and that those capacitors may be electrolytic capacitors.

A person skilled in the art will appreciate that whilst the above has described the resistive soft-start system 118 as being positioned between the supply neutral 114 and the rectifier 110, it could alternatively or additionally be connected between the supply line 112 and the rectifier 110.

There is described herein a damage limitation approach comprising determining that a voltage produced by a rectifier circuit is indicative of a fault and consequently controlling a switch operable to bypass a resistive element of a circuit via which the rectifier circuit is supplied.

A person skilled in the art will appreciate that the terms “undervoltage time period”, “overvoltage time period”, and “damage level time period” are labels for time periods that have been predetermined as appropriate to use as indications respectively that: a detected voltage below the undervoltage threshold for normal operation is indicative of a fault; a detected voltage above the overvoltage threshold for normal operation is indicative of a fault; and a detected voltage above the damage level threshold is indicative of a fault. The skilled person will further understand that the terms “undervoltage threshold for normal operation”, “overvoltage threshold for normal operation”, and “damage level threshold” are labels for voltage thresholds that have been predetermined as appropriate to use as indications that a detected voltage is indicative of a fault.

1. A damage limitation method for use with a device having a rectifier circuit and a soft-start circuit coupled to an input of the rectifier circuit, the soft-start circuit having: a resistive element for passing current between a source and the rectifier circuit, and a switch operable to allow current passing between the source and the rectifier circuit to bypass the resistive element, the method comprising the steps of:
detecting a voltage at an output of the rectifier circuit;
determining that the detected voltage is indicative of a fault; and
responsive to determining that the detected voltage is indicative of a fault, controlling the switch of the soft-start circuit.

2. The method of claim 1, wherein the controlling the switch step comprises closing the switch so as to allow current passing between the source and the rectifier circuit to bypass the resistive element of the soft-start circuit.

3. The method of claim 1, wherein the determining that the detected voltage is indicative of a fault step comprises determining that the detected voltage is less than an undervoltage threshold for normal operation, optionally wherein the determining that the detected voltage is indicative of a fault step comprises determining that the detected voltage has been less than the undervoltage threshold for normal operation for a predetermined undervoltage time period or longer.

4. The method of claim 3, wherein the determining that the detected voltage is indicative of a fault step comprises determining that the rate of change of the detected voltage is less than a predetermined rate of change of voltage.

5. The method of claim 1, wherein the determining that the detected voltage is indicative of a fault step comprises determining that the detected voltage is greater than a damage level threshold, optionally wherein the determining that the detected voltage is indicative of a fault step comprises determining that the detected voltage has been greater than the damage level threshold for a predetermined damage level time period or longer.

6. The method of claim 1, wherein the determining that the detected voltage is indicative of a fault step comprises determining that the rate of change of the detected voltage is greater than a predetermined rate of change of voltage.

7. The method of claim 1, wherein the controlling the switch step comprises opening the switch so as to prevent current passing between the source and the rectifier circuit from bypassing the resistive element of the soft-start circuit.

8. The method of claim 7, wherein the determining that the detected voltage is indicative of a fault step comprises determining that the detected voltage is greater than an overvoltage threshold for normal operation, optionally, wherein the determining that the detected voltage is indicative of a fault step comprises determining that the detected voltage has been greater than the overvoltage threshold for a predetermined overvoltage time period or longer.

9. The method of claim 7, wherein the determining that the detected voltage is indicative of a fault step further comprises determining that the detected voltage is less than a damage threshold.

10. The method of claim 1 wherein the rectifier circuit comprises a capacitive voltage multiplier circuit.

11. A computer readable medium carrying machine readable instructions arranged upon execution by a processor to cause the processor to carry out the method of claim 1.

12. A damage limitation apparatus for use with a device having a rectifier circuit and a soft-start circuit coupled to an input of the rectifier circuit, the soft-start circuit having: a resistive element for passing current between a source and the rectifier circuit, and a switch operable to allow current passing between the source and the rectifier circuit to bypass the resistive element, the apparatus being arranged to:
detect a voltage at an output of the rectifier circuit;
determine that the detected voltage is indicative of a fault; and
responsive to determining that the detected voltage is indicative of a fault, control the switch of the soft-start circuit.

13. The apparatus of claim 12, wherein the apparatus is arranged to control the switch by closing the switch so as to allow current passing between the source and the rectifier circuit to bypass the resistive element of the soft-start circuit.

14. The apparatus of claim 12, wherein the apparatus is arranged to determine that the detected voltage is indicative of a fault by determining that at least one of:
the detected voltage is less than an undervoltage threshold for normal operation;
the detected voltage has been less than the undervoltage threshold for normal operation for a predetermined undervoltage time period or longer;
the rate of change of the detected voltage is less than a predetermined rate of change of voltage; and
the detected voltage is greater than a damage level threshold, optionally wherein the apparatus is arranged to determine that the detected voltage is indicative of a fault by determining that the detected voltage has been greater than the damage level threshold for a predetermined damage level time period or longer.

15. The apparatus of claim 12, wherein the apparatus is arranged to determine that the detected voltage is indicative of a fault by determining that the rate of change of the detected voltage is greater than a predetermined rate of change of voltage.

16. The apparatus of claim 12, wherein the apparatus is arranged to control the switch by opening the switch so as to prevent current passing between the source and the rectifier circuit from bypassing the resistive element of the soft-start circuit.

17. The apparatus of claim 16, wherein the apparatus is arranged to determine that the detected voltage is indicative of a fault by determining that the detected voltage is greater than an overvoltage threshold for normal operation, optionally wherein the apparatus is arranged to determine that the detected voltage is indicative of a fault step by determining that the detected voltage has been greater than the overvoltage threshold for a predetermined overvoltage time period or longer.

18. The method of claim 16, wherein the determining that the detected voltage is indicative of a fault step further comprises determining that the detected voltage is less than a damage threshold.

19. The apparatus of claim 12 wherein at least one of:
the rectifier circuit comprises a capacitive voltage multiplier circuit; and
the switch is a relay.

20. A damage limitation apparatus being arranged to determine that a voltage produced by a rectifier circuit is indicative of a fault and consequently control a switch operable to bypass a resistive element of a soft-start circuit via which the rectifier circuit is supplied.
